(19) United States
(12) Patent Application Publication
(10) Pub. No.: US 2004/0076102 A1
(43) Pub. Date: Apr. 22, 2004

(54) Locking mechanism for external cover-lifting optical disk drive

(76) Inventor: Hui-Chu Huang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/379,030

(22) Filed: Mar. 4, 2003

(30) Foreign Application Priority Data
Oct. 18, 2002 (TW) 91216713

(51) Int. Cl. G11B 33/02

(52) U.S. Cl. 369/75.1

(57) ABSTRACT

The present invention is directed to a locking mechanism for use in an external optical disk drive. The locking mechanism includes a switch supporting base, a push rod, a locking member and an electromagnetic switch. An elastic member is fitted to the push rod, and both ends of the elastic member are restrained by the push rod and the switch supporting base. To open the cover, the locking member disengages from the cover by the electromagnetic switch and the push rod pushes the cover upwardly due to the elastic member. To lock the cover, the push rod is restrained by the switch supporting base and the push rod does not contact the cover. Thus, there is no force applied to the cover, and the cover is simply restrained by the locking member.

### BACKGROUND OF THE INVENTION

1. Field of the Invention

The invention relates to a locking mechanism for an external cover-lifting optical disk drive and in particular, to a locking mechanism for releasing or locking a cover of an external cover-lifting optical disk drive.

2. Description of the Related Art

Generally speaking, optical disk drives are used to read/write information stored on an optical disk. Examples of optical disk drives are known in the art as compact disk drives and digital versatile disk drives. Some optical disk drives have the additional capability of being able to write data onto an optical disk. Optical disk drives are being used in various applications comprising music and video playing and recording devices and host computer data storage devices.

One type of optical disk drives has an independent housing (often referred as an external type), and is coupled to a host computer via a signal cable to transmit data to the host computer. In addition, the external optical disk drive may transmit data to the users via an earphone cable.

In prior art, the conventional disk loading and disk ejection methods include disk-tray type and cover-lifting type. Regarding the disk-tray type disk drive, the optical disk can be placed on the disk tray when a disk tray motor pulls the disk tray to what so called pull-out position. As shown in FIG. 1, the disk-tray optical disk drive includes a rectangular-shaped slit 11 surrounding the disk tray. However, due to the slit 11, the disk tray may be jammed by foreign objects during loading and ejection of the optical disk. Besides, the cover-lifting optical disk drive is normally applied to multimedia playback device. FIG. 2 and FIG. 3 show a conventional locking mechanism for a cover-lifting optical disk drive. The cover-lifting optical disk drive includes a cover 100 and a lower housing assembly 200. The cover 100 includes an opening 101 at its front edge, a rod 102 extending downwardly the front edge and beside the opening 101, and a rotary shaft 103 at its rear edge. The rotary shaft 103 is pivotally coupled to the lower housing assembly 200 so that the cover 100 can be pivoted with respect to the lower cover assembly 200. To effectively utilize the space occupied by the optical disk drive, the rotary shaft 103 is not located at a central portion of the rear edge of the cover 100. Further, the hook 300 engages with the opening 101 for the purpose of securing the cover 100 to the lower housing assembly 200. When the cover 100 is locked, a force F is applied to the rod 102 of the cover 100 by a torsion spring 400. As described above, the force F of the torsion spring 400 is applied to the rod 102 that is not located at the central portion of the front edge of the cover 100. Thus, the rotary shaft 103 that is slightly open. Due to a displacement D at the front edge of the cover 100, the cover 100 is deformed. The deformation of cover 100 may be aggravated during transport when environmental temperature is high, thereby rendering the finished product unusable prior to selling.

Accordingly, there is a need to develop a locking mechanism for use in an external optical disk drive.

### SUMMARY OF THE INVENTION

It is an object of the present invention to provide a locking mechanism for an external optical disk drive that can effectively eliminate the deformation of a cover.

It is another object of the present invention to provide an external optical disk drive that a locking mechanism is used to secure a cover smoothly.

The present invention provides a locking mechanism for use in an external optical disk drive. In one embodiment of the present invention, the locking mechanism is disposed between the upper housing and the lower housing to release or lock the cover. The cover has a projection extending downwardly from its front end. The locking mechanism includes a switch supporting base, a push rod, a locking member and an electromagnetic switch. The protrusion extends downwardly from a front edge of the cover and includes an opening. The push rod includes an extension and a pivotal shaft. An elastic member is adapted to receive the push rod, and both ends of the elastic member are restrained by the push rod and the switch supporting base. To open the cover, the locking member disengages from the opening of the cover by the electromagnetic switch and the push rod contacts the projection and pushes the cover upwardly due to the elastic member. To lock the cover, the push rod is restrained by the switch supporting base and the push rod does not contact the projection. Thus, there is no force applied to the cover, and the cover is simply restrained by the locking member.

### BRIEF DESCRIPTION OF THE DRAWINGS

The present invention can be more fully understood by reading the subsequent detailed description and examples with references made to the accompanying drawings, wherein:

FIG. 1 is a perspective view of a conventional disk-tray optical disk drive;

FIG. 2 is a front perspective view of a conventional cover-lifting optical disk drive;

FIG. 3 is a perspective view of a cover of the optical disk drive of FIG. 2;

FIG. 4 is an exploded perspective view of an optical disk drive according to the present invention;

FIG. 5 is an exploded perspective view of the optical disk drive of FIG. 4 as viewed from the lower housing; and

FIG. 6 is a partial enlarged perspective view of the present invention of FIG. 4.

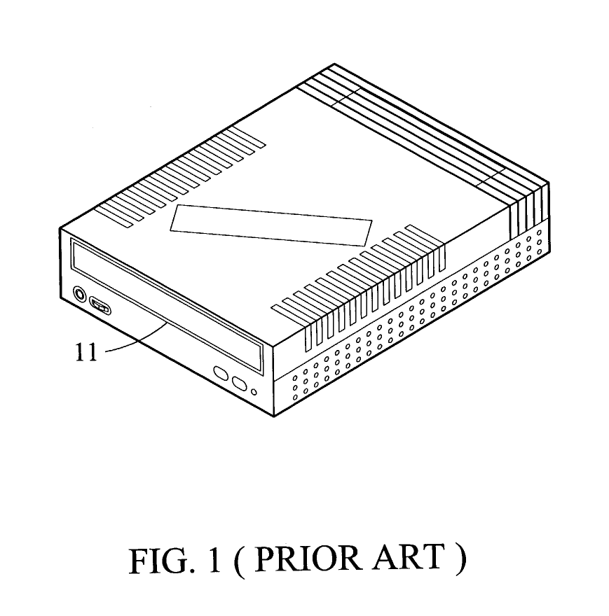

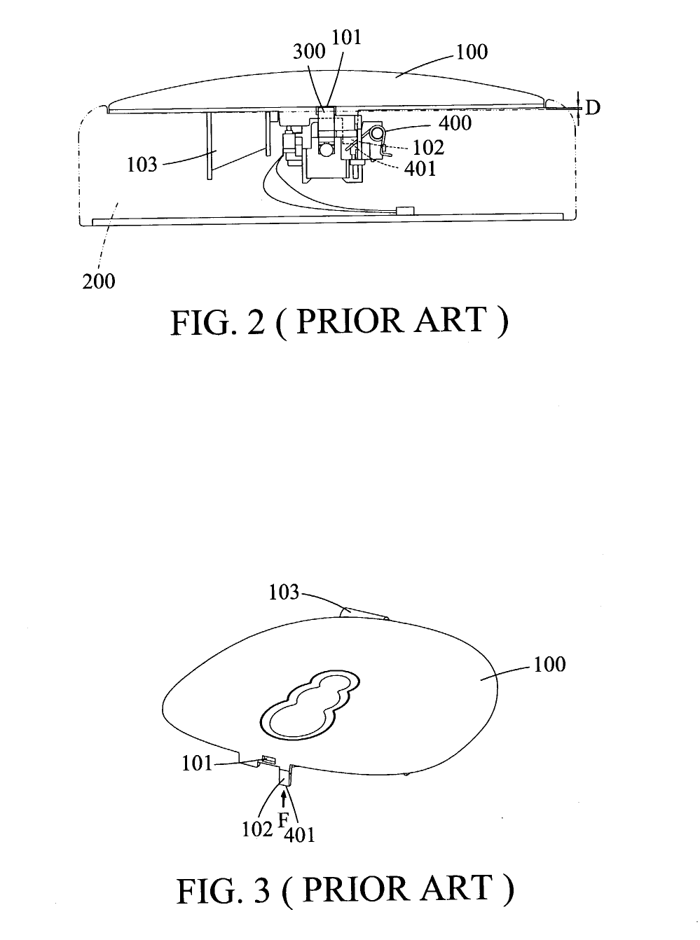

### DETAILED DESCRIPTION OF THE INVENTION

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

Although the embodiments of the present invention are described below in connection with a cover-lifting optical disk drive, the present invention can be applied to all optical disk drive, including but not limited to CD-ROM drives, CD-RW drives, DVD-R/RW drives, COMBO drives, car audio players, as well as all other optical media recorders and players.

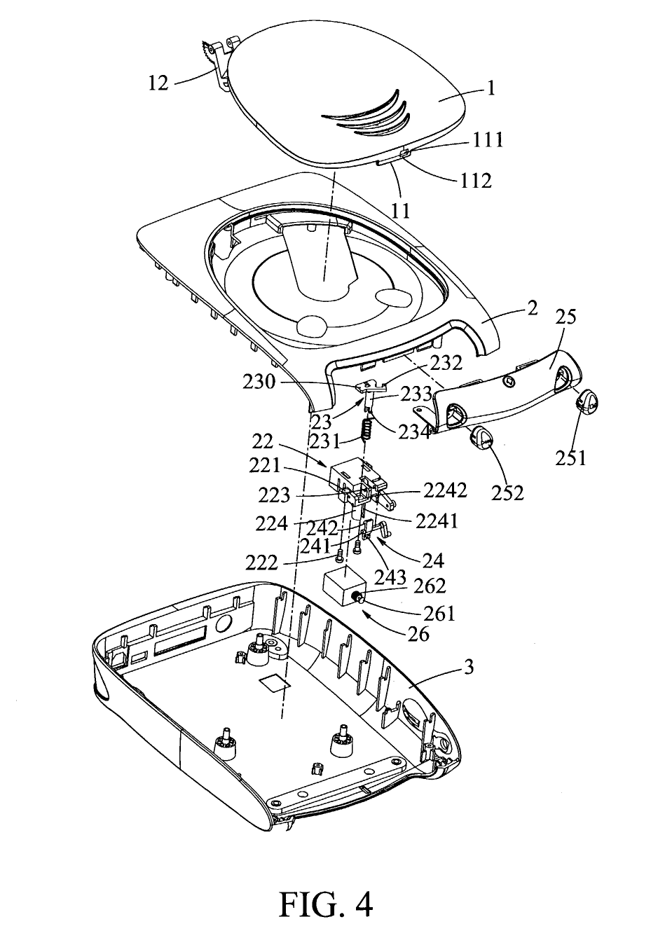

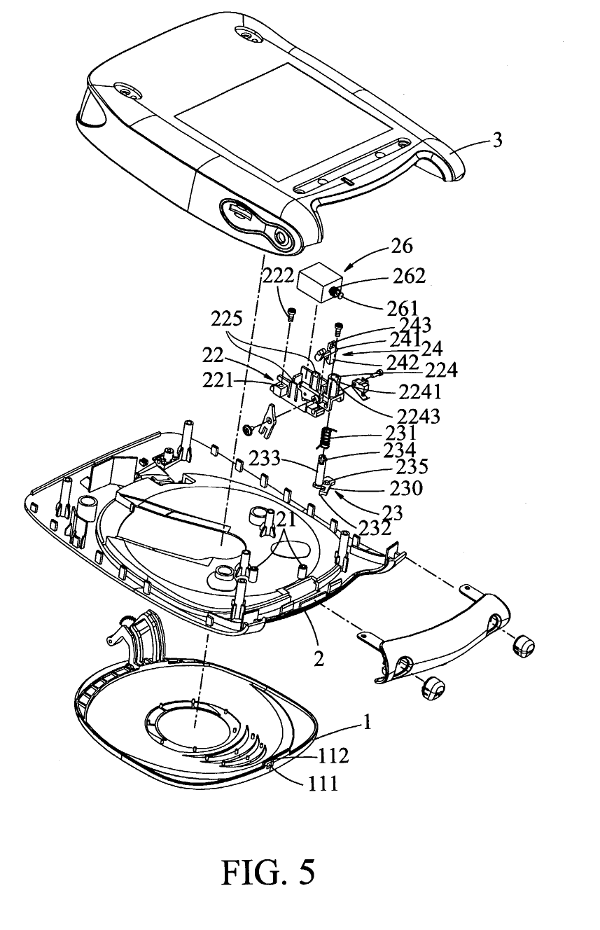

FIG. 4 is an exploded perspective view of a locking mechanism for a cover-lifting optical disk drive according to the present invention. FIG. 5 is an exploded perspective view of the optical disk drive of FIG. 4 as viewed from the lower housing. Referring to FIG. 4, the optical disk drive includes a cover 1, an upper housing 2, a front cover 25 and a lower housing 3. The cover 1 includes a protrusion 11 extending downwardly from its front end, and an opening 111 is defined in the protrusion 11. A contact portion 112 is integrally formed with the protrusion 11. The upper housing 2 is positioned at the lower housing 3, and the front cover 25 is positioned at the optical disk drive.

Referring to FIG. 4, the locking mechanism according to the present invention includes a switch supporting base 22, a push rod 23, a locking member 24 and an electromagnetic switch 26. As shown in FIG. 5, the upper housing 2 includes two supports 21 at its bottom surface, and two screw holes 221 are defined on the switch supporting base 22. Two screws 222 respectively extend through the two screw holes 221 to threadly engage with upper housing 2. In this manner, the switch supporting base 22 can be fixed to the bottom surface of the upper housing 2. An electromagnetic switch 26 is adapted to be snapped into the switch supporting base 22 by hooks 225. The electromagnetic switch 26 includes a retractable shaft 261 and an elastic member 262 is compressed by the retractable shaft 261.

Further referring to FIG. 4, a locking member 24 includes a rotary shaft 241, a hook 242 and a fork-shaped extension 243. The rotary shaft 241 of the locking member 24 is pivotally coupled to a hole 223 that is positioned at the switch supporting base 22. The opening 111 of the cover 1 is adapted to receive the hook 242. The fork-shaped extension 243 of the locking member 24 is adapted to receive the retractable shaft 261. Thus, the locking member 24 pivots about the phantom line A of FIG. 4 during the ejection and loading of the optical disk.

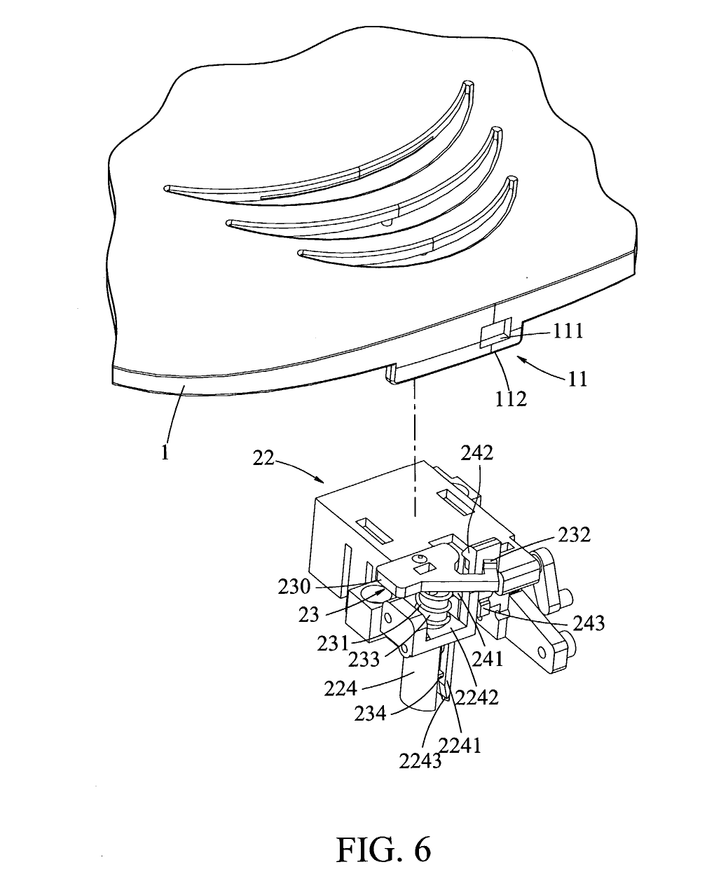

A push rod 23 includes a top portion 230, a V-shaped extension 232, a pivotal shaft 233, a pin 234 and a guide pin 235. The V-shaped extension 232 extends from the top portion 230, and the pivotal shaft 233 extends downwardly from the top portion 230. The pin 234 of the push rod 23 is formed at the lower end of the pivotal shaft 233. The guide pin 235 is defined on the bottom surface of the top portion 230 as shown in FIG. 5. An elastic member 231 is adapted to receive the pivotal shaft 233 and is restrained by the guide pin 235 of the push rod 23 and the switch supporting base 22. The elastic member 231 is of metallic (plastic) and can be a torsion spring. Besides, the push rod 23 and elastic member 231 are inserted into a tube 224 of the switch supporting base 22. Thus, a torsional moment M is produced so that the elastic member 231 pivots about the pivotal shaft 233 as shown in FIG. 4. The tube 224 extends downwardly from the switch supporting base 22 and includes a longitudinal recess 2241 defined in its circumferential wall. The pin 234 of the push rod 23 releasably engages with a notch 2243 of the switch supporting base 22, as shown in FIG. 6.

Referring to FIGS. 4-6, when the user wants to open the cover 1, the electromagnetic switch 26 extends in the direction of arrow B so that the locking member 24 is pushed to pivot about the rotary shaft 241 in the direction of the phantom line A. Due to the engagement between the pivoting shaft 261 and the fork-shaped extension 243, the hook 242 of the locking member 24 disengages from the opening 111 of the cover 1. Further, the push rod 23 is forced to pivot about the pivotal shaft 233 when the hook 242 pushes the V-shaped extension 232 of the push rod 23 in the reverse direction of arrow B. Until the pin 234 of the push rod 23 disengages from the notch 2243, the push rod 23 moves upwardly and contacts the contact portion 112 of the cover 1 due to the resilience of the elastic member 231. Because the hook 242 of locking member 24 already disengages from the opening 111 of the cover, the push rod 23 pushes the contact portion 112 of the cover 1 upwardly. Thus, the cover 1 of the external optical disk drive is opened.

Further referring to FIGS. 4-6, when the user wants to close the cover 1, the contact portion 112 of the cover 1 contacts and pushes the push rod 23 downwardly. Then, the contact portion 112 of the cover 1 pushes the hook 242 of the locking member 24 in the reverse direction of arrow B. The locking member 24 is pushed to pivot about the rotary shaft 241 along the phantom line A. Besides, the hook 242 pushes the V-shaped extension 232 of the push rod 23 against the torsional moment M. The push rod 23 is forced to pivot about the pivotal shaft 233 and pushed downwardly by the cover 1. Until the pin 234 of the push rod 23 engages with the notch 2243, the push rod 23 is refrained by the notch 2243 as shown FIG. 6. Besides, the hook 242 of the locking member 24 is locked by the opening 111 of the cover 1. The top portion 230 of the push rod 23 does not contact the contact portion 112 of the cover 1 when the cover 1 is manually closed. Thus, the cover 1 is not subjected to a force F as described in the prior art, and the cover 1 is not deformed because of the force F.

While the invention has been described by way of example and in terms of the preferred embodiment, it is to be understood that the invention is not limited to the disclosed embodiment. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A locking mechanism for an external optical disk drive with a cover and an upper housing, comprising:
a protrusion, extending downwardly from the cover;
a switch supporting base, disposed in the upper housing;
a push rod, disposed in the switch supporting base;
an elastic member, adapted to receive the push rod and disposed in the switch supporting base; and
a locking member, pivotally coupled to the switch supporting base.

2. The locking mechanism as claimed in claim 1, wherein the locking member has a hook and the protrusion comprises an opening that is adapted to receive the hook when the cover is closed manually.

3. The locking mechanism as claimed in claim 1, further comprising an electromagnetic switch that is snapped into the switch supporting base and has a retractable shaft.

4. The locking mechanism as claimed in claim 1, wherein the elastic member is restrained between the push rod and the switch supporting base.

5. The locking mechanism as claimed in claim 1, wherein the elastic member is torsion spring that is metallic or plastic.

6. The locking mechanism as claimed in claim 1, wherein the switch supporting base can be fixed to the bottom surface of the upper housing by two screws.

7. The locking mechanism as claimed in claim 1, wherein the push rod includes a top portion used to push the protrusion upwardly when the cover is opened manually.

8. The locking mechanism as claimed in claim 1, wherein the push rod has a guide pin and the switch supporting base has a notch, and the notch is adapted to receive the guide pin when the cover is manually closed.

9. The locking mechanism as claimed in claim 3, the locking member includes a fork-shaped extension that is adapted to receive the retractable shaft.

10. A locking mechanism for an external optical disk drive with a cover and an upper housing, comprising:
a protrusion, extending downwardly from the cover and having an opening;
a switch supporting base, fixed to the bottom surface of the upper housing;
a push rod, having a top portion and disposed in the switch supporting base;
an elastic member, adapted to receive the push rod and disposed in the switch supporting base; and
a locking member, adapted to lock the opening of the protrusion and pivotally coupled to the switch supporting base.

11. The locking mechanism as claimed in claim 10, wherein the top portion of push rod pushes the protrusion upwardly when the cover is manually opened.

12. The locking mechanism as claimed in claim 10, wherein the elastic member is restrained between the push rod and the switch supporting base.

13. The locking mechanism as claimed in claim 10, wherein the elastic member is torsion spring that is metallic or plastic.

14. The locking mechanism as claimed in claim 10, further comprising an electromagnetic switch that is snapped into the switch supporting base and has a retractable shaft.

15. The locking mechanism as claimed in claim 11, the locking member includes a fork-shaped extension that is adapted to receive the retractable shaft.
